(19) United States
(12) Patent Application Publication
(10) Pub. No.: US 2002/0087541 A1
(43) Pub. Date: Jul. 4, 2002

(54) Method of registering users in a centralized database through a plurality of internet sites

(75) Inventors: Adam Ceton, Auburn Hills, MI (US); Patrick Callow, Grosse Pointe Park, MI (US); Mike Tius, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: eRegister, Inc.

(21) Appl. No.: 09/753,447

(22) Filed: Jan. 3, 2001

(51) Int. Cl. G06F 17/30

(52) U.S. Cl. 707/9

(57) ABSTRACT

A method of registering information for a user in a centralized user database (24) accessible by a plurality of subscribers. The method comprises establishing a first internet site (12) having a first plurality of identity fields (14) for inputting user information into and a second internet site (32) having a second plurality of identity fields (34) and linking both to the centralized user database (24). The method further includes a master list of identity fields (26) for comparing the first plurality of identity fields (14) and the second plurality of identity fields (34). The method is characterized by populating the user information registered in the centralized user database (24) from the first internet site (12) to the second plurality of identity fields (34) on the second internet site (32). The second internet site (32) may have one additional identity field (40) different than the first plurality of identity fields (14) and identity fields which are unique to the second internet site (32).

### BACKGROUND OF THE INVENTION

1. Field of the Invention

The subject invention relates to a method of registering information for a user in a centralized user database accessible by a plurality of subscribers.

2. Description of the Prior Art

Various methods are known for registering information for a user in a database which is accessible by a subscriber. The method includes the steps of establishing a first internet site or form having a first plurality of identity fields, establishing a database comprising a master list of identity fields, and linking the database to the first form. The user then inputs the user information into the first plurality of identity fields and registers the user information from the first plurality of identity fields into the centralized user database.

One such method is shown in U.S. Pat. No. 6,092,053 to Boesch et al. The ′053 patent discloses a method for gathering purchasing information for registered users. The user inputs their information into a database and the information is used for making future purchases. The user does not need to reenter his purchase information because it is stored in the database. The user and the subscriber have access to the information, in so much as they are given a summary of their transactions over a period of time. However, this method does not allow the information to be automatically displayed into a form different than the one the user input the information into displayed by the subscriber. The method also does not allow different subscribers to access the information input by the user.

### SUMMARY OF THE INVENTION AND ADVANTAGES

The subject invention provides a method of registering information for a user in a centralized user database accessible by a plurality of subscribers. The method comprises the steps of establishing a first internet site having a first plurality of identity fields, inputting user information into the first plurality of identity fields, establishing a centralized user database comprising a master list of identity fields, and linking the centralized user database to the first internet site. The user information input into the first plurality of identity fields is then compared to the master list of identity fields and registered into the centralized user database. The method further includes establishing a second internet site having a second plurality of identity fields and linking the centralized user database to the second internet site. The method is characterized by populating the user information registered in the centralized user database from the first internet site into the second plurality of identity fields on the second internet site.

Accordingly, the user information is registered into the centralized user database and automatically populated into the second internet site. The user will be more likely to register at a subscriber's internet site because the user does not have to input the information into each identity field for each form. Additionally, the user is given an opportunity to change the user information in the centralized database when the user information is displayed in the identity field. The user may also change the user information in the centralized database by directly connected to the centralized database. Furthermore, the subscriber of each of the internet sites can request the user information from the centralized user database and the subscriber retrieves the user information as input by the user. This allows the subscriber to offer the user advantages which result from registering at the subscriber's internet site.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is schematic view of a method of registering information for two users from two computers in a centralized user database accessible by a plurality of subscribers;

FIG. 2 is flowchart representing the steps of the method for registering information;

FIG. 3 is a schematic view of an identity field having a field name and a descriptive field;

FIG. 4 is a schematic view comparing of the master list of identity fields to the plurality of identity fields in the field description database;

FIG. 5 is a schematic view of the interaction between a centralized user database and a first and second internet sites; and

FIG. 6 is a schematic view of the interaction between an owner of the database and a subscriber and the first and second internet sites.

### DETAILED DESCRIPTION OF THE PREFERRED EMBODIMENT

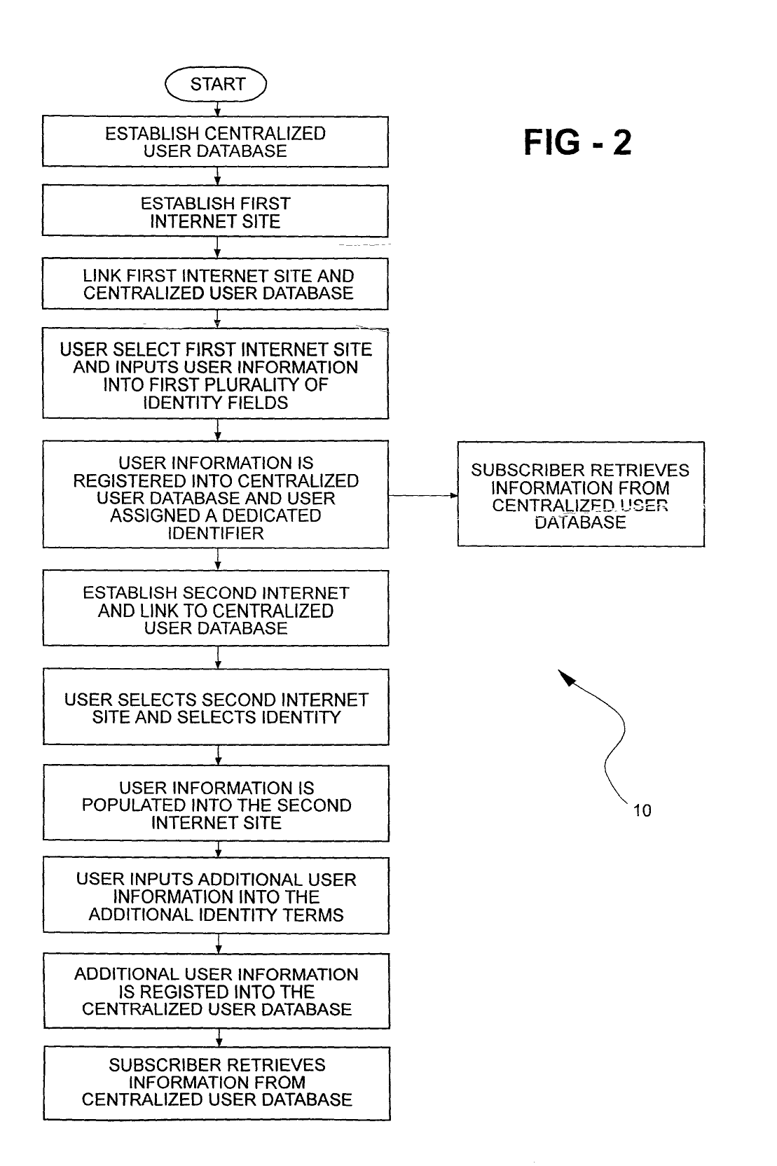

Referring to the Figures, wherein like numerals indicate like or corresponding parts throughout the several views, a method of registering information for a user in a centralized user database accessible by a plurality of subscribers is shown generally at 10 in FIG. 2.

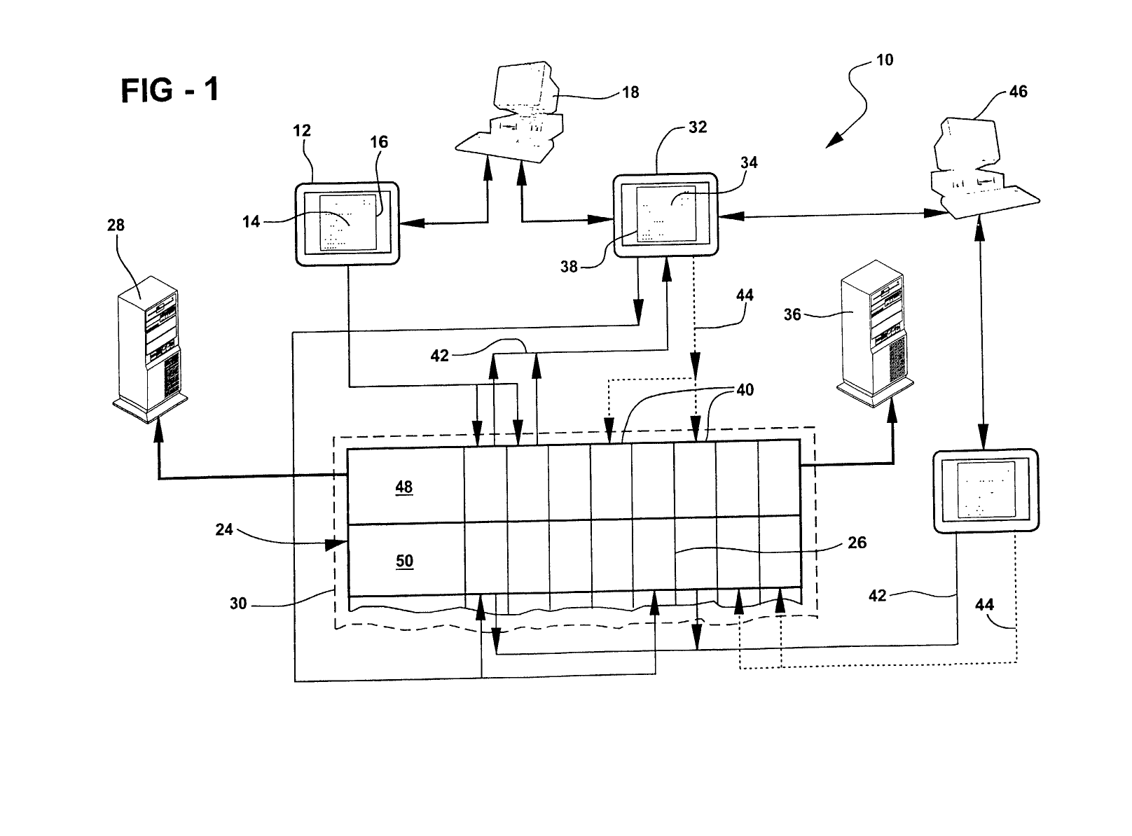

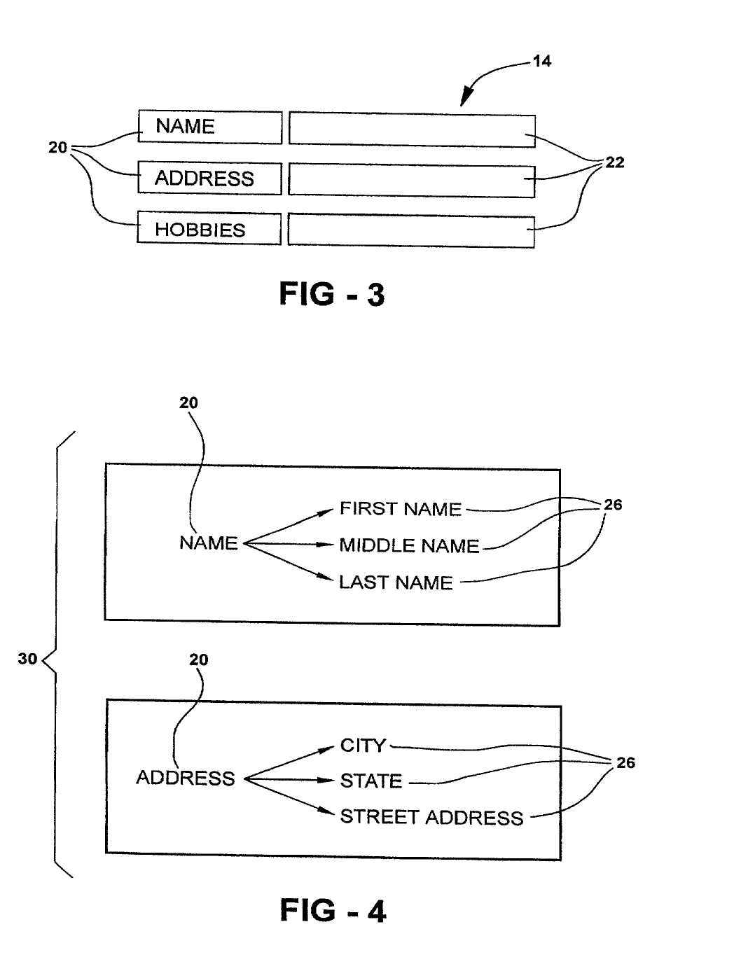

The first step of the method comprises establishing a first internet site 12 having a first plurality of identity fields 14, shown in FIG. 1. The first internet site 12 is owned and operated by a first subscriber 28 who is either an individual or a company. The first internet site 12 preferably has a first form 16 displaying the first plurality of identity fields 14 to a first user 18 for inputting user information into the first plurality of identity fields 14. A second user 46 can also select the first internet site 12 and input the second user information into the first form 16. The user can connect to the first internet site 12 by accessing the world wide web (WWW) by any connection as is known in the art. The first internet site 12 must only present the user with an interface and is not limited to access through the WWW. The user visits the first internet site 12 and selects the form to be displayed. The form is preferably for registering the user information with the first internet site 12 for such events as registering for a class, activity or the like. The user inputs the user information into the first plurality of identity fields 14. Each of the plurality of identity fields includes a field name 20, or question, and a descriptive field 22, or answer, as shown in FIG. 3. The field name or question 20 prompts the user to input the corresponding user information into the descriptive field or answer 22. One such example of a question 20 would be “What is your gender?” where the user inputs or selects “male” or “female” for the answer 22.

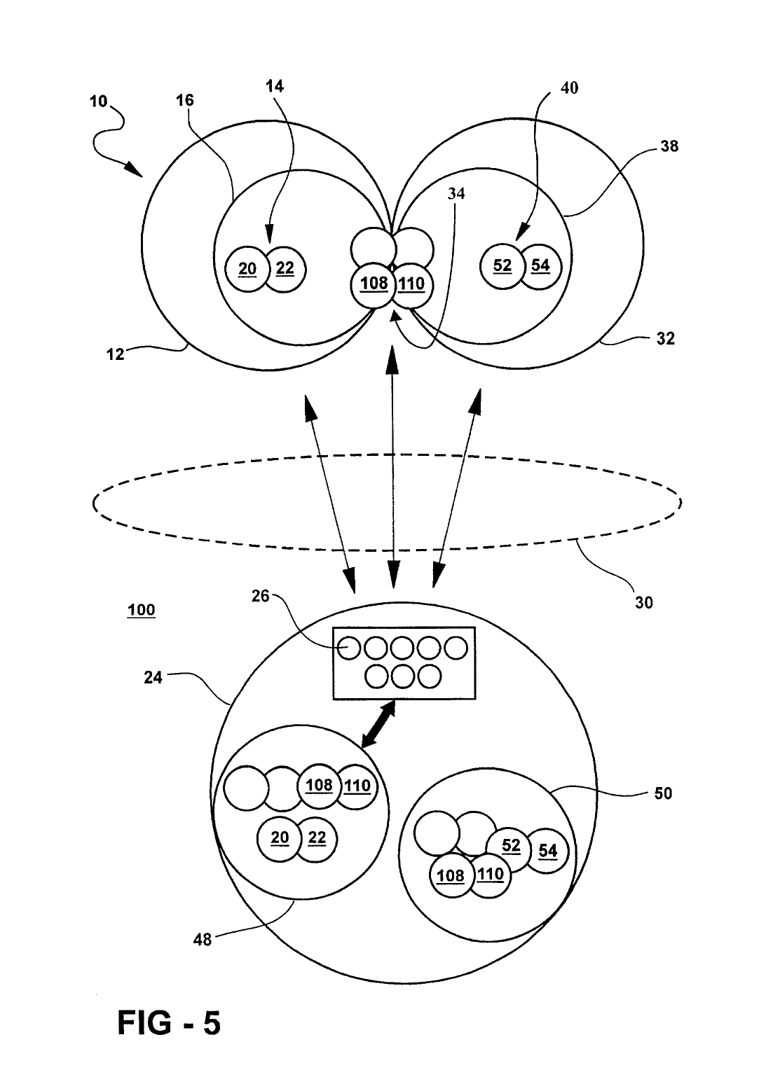

The method further includes establishing a centralized user database 24 comprising a master list of identity fields 26, shown generally in FIG. 5. The centralized user database 24 is preferably owned and operated by a different individual or company than the company which established the first internet site 12. However, it is possible that the owner of the centralized database may also be the owner of the first internet site 12. The owner of the centralized database may contact or be contacted by the first subscriber 28 for linking the centralized user database 24 to the first internet site 12. After the first internet site 12 and the centralized user database 24 are linked, the master list of identity fields 26 is compared to the first plurality of identity fields 14. The master list of identity fields 26 and the plurality of identity fields 14 are linked to a field description database 30, as shown in FIG. 5. The field description database 30 matches the user information input by the user in the descriptive field 22 of the internet site with the appropriate field in the master list of identity fields 26. For example, as shown in FIG. 4, if the first internet site 12 includes a field name 20 of “NAME”, then the user inputs his full name into the descriptive field 22. However, if the field in the master list of identity fields 26 is broken down into “FIRST NAME” and “LAST NAME”, then the field description database 30 recognizes that the user information input into the first internet site 12 is to be put into the corresponding identity field in the centralized user database 24. In other words, the field name 20 selected by the first subscriber 28 can be different than the fields in the master list of identity fields 26 because the fields will be matched by the field description database 30. The user information is then registered in the centralized user database 24. In FIG. 1, the first user 18 registers his user information into the centralized user database 24 at a position 48 and the second user 46 registers his user information into the centralized user database 24 at a position 50.

Next, a second internet site 32 is established having a second plurality of identity fields 34. The second internet site 32 may be owned by a second subscriber 36 who may be the same company as the first internet site 12, but may be a different company or individual. The first subscriber may additionally have multiple internet sites displaying different forms. The second internet site 32 preferably has a second form 38 displaying the second plurality of identity fields 34 to the user. The second plurality of identity fields 34 also includes a second field name 108, or question, and a second descriptive field 110, or answer. The user, after registering at the first internet site 12, is assigned and identified by a dedicated identifier which is unique to the user. Each user has a different dedicated identifier for identifying which user is at each of the internet sites corresponding to the first user's information 48 and the second user's information 50. The user may still be required to enter a password to validate his identity or any other method as is known in the prior art for validating the user identity. One such example of a dedicated identifier would be to use a “cookie”, which is recognized by the user's web browser. Other similar techniques may be employed as is known in the art of identifying a user to a network.

The method is characterized by populating the user information registered in the centralized user database 24 from the first internet site 12 to the second plurality of identity fields 34 on the second internet site 32, shown in FIG. 1 as solid lines 42. In one embodiment, after the user has been identified at the second internet site 32, a popup window prompts the user to select his identity. The user then selects his identity and the user information contained in the centralized user database 24 is populated into the second descriptive field 110 on the second internet site 32. The second internet site 32 and the first internet site 12 have in common the second field name or question 108 and the second descriptive field or answer 110.

The second internet site 32 may have one additional identity field 40 different than the first plurality of identity fields 14. The additional identity field 40 has a third field name or question 52 and a third descriptive field or answer 54. After the user information from the centralized user database 24 has been populated into the second descriptive field 110 of the second plurality of identity fields 34, the third descriptive field 54 of the additional identity field 40 remains blank. The user then inputs additional user information into the third descriptive field 54 of the additional identity field 40. The user then registers the additional user information from the second internet site 32 into the centralized user database 24, shown in FIG. 1 as dotted lines. The additional user information may then be populated into any other internet site where the user selects a form for registering. If the additional identity field 40 was not already present in the centralized user database 24, the additional identity field 40 is created in the centralized user database 24 when the user registers the additional user information.

The user is also able to update his information contained in the centralized user database 24. In one embodiment, the information is populated into an internet site and the user may input new user information over the user information in the descriptive field 22. The new user information is registered in the centralized user database 24. The new user information may be stored along with the old information in the centralized user database 24 or the old user information may be discarded. The user may be prompted to select whether or not the user prefers the old user information to be discarded or to be saved. Alternately, the user may directly log into the centralized user database to change the user information.

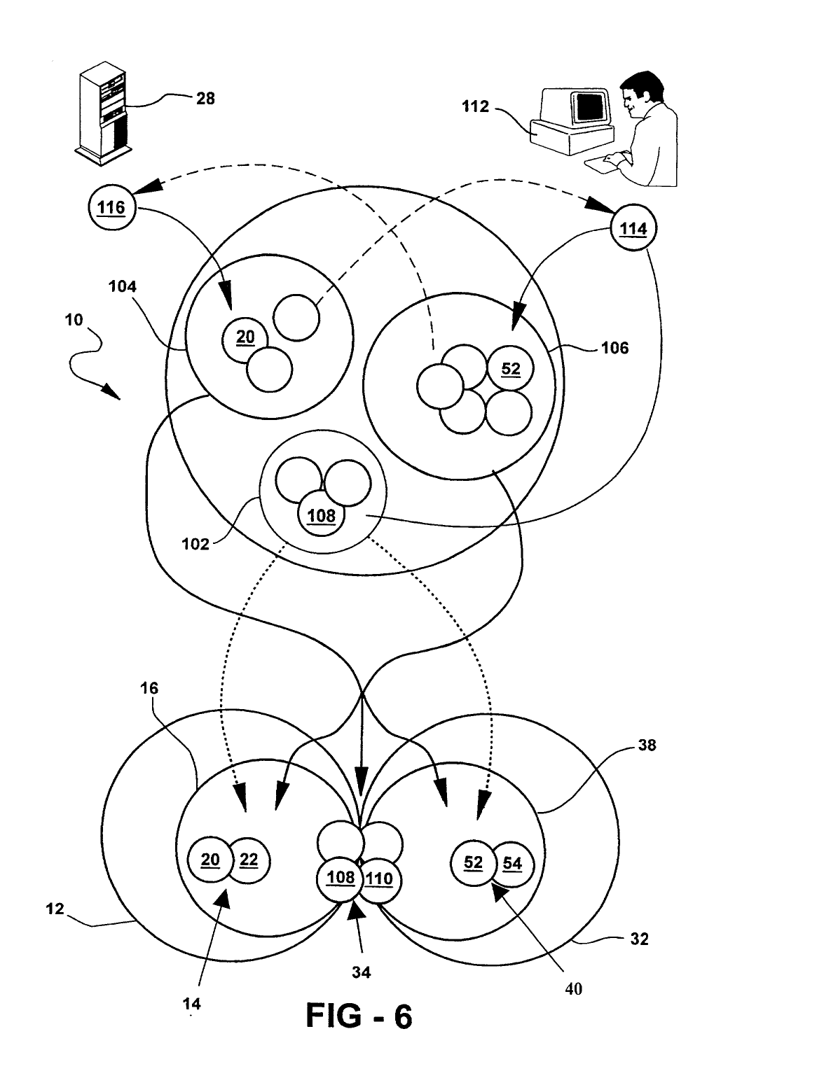

The identity fields 14, 34 displayed to the user are selected by either one of the subscribers 28 and the owner 112 of the user database 24. In FIG. 6, the owner 112 of the user database 24 has a first set 102 of identity fields which are required and a second set 106 of identity fields which are optional to be displayed to the user. The subscriber 28 has a third set 104 of identity fields which the subscriber may select to display to the user. The owner 112 of the user database 24 and the subscriber 28 are able to select any combination of identity fields from their sets 102, 104, 106 for display to the user. For example, if multiple subscribers 28 are utilizing the same identity field, the owner 112 of the user database 24 may move the identity field into the required set 108. The subscribers 28 of the internet sites can also create additional identity fields 40 in the centralized user database 24 by requesting the user to enter the specific information at either one of the internet sites. The subscribers of the internet site can request the owner of the centralized user database 24 to create a specific field name 20 in the master list of identity fields 26. Additionally, each of the internet sites are issued an access code for establishing communication with and retrieving user information from the centralized user database 24 and be displayed on a subscriber terminal 28, 36. The internet sites can request user information from the centralized user database 24 and access a predetermined number of identity fields. For example, the first subscriber 28 may request user name, address, and hobbies while the second subscriber 36 may request user name, address, age, family, and hobbies. The second subscriber 36 may be required to pay a larger fee than the first subscriber 28 to receive the additional user information. It is also possible to prevent the subscribers from retrieving certain information based on the preferences of the user or the owner 112 of the centralized user database 24.

FIG. 5 illustrates a user interacting with the centralized user database 24 through a internet site. The first user accesses the first internet site 12 or the second internet site 32. The first internet site 12 has the first form 16 with the plurality of identity fields 14 containing the field name or question 20 and the descriptive field or answer 22. The first internet site 12 also has the second field name 108 and second descriptive field 110 which is used on both internet sites 12, 38. The user inputs his user information into the first internet site 12 and registers the first user information into the centralized user database 24. Before the first user information is registered, the field names 20 are compared to the master list of identity fields 26 and the field description database 30 for accurately registering the information into the centralized user database 24. The first user information is then registered into the centralized user database 24. The first user then accesses the second internet site 32. The second internet site 32 has the second form 38 with the second plurality of identity fields 34 containing the third field name or question 52 and the third descriptive field or answer 54. The second internet site 32 also has the second field name 108 and second descriptive field 110 which is used on both internet sites 12, 38. The registered first user information is automatically populated into the descriptive field 110 on the second form 38. A second user's information 50 is able to be stored in the centralized user database 24.

FIG. 6 illustrates the owner 112 of centralized user database 24 having a first set 102 of required field names and a second set 106 of optional field names. The subscriber 28 has a third set 104 of optional field names. The owner 112 may select a field name 114 and put it in either the first set 102 or the second set 106 of field names. Additionally, the owner 112 may select the field name 114 from the third set 104 and put it in the first 102 or second 106 set. The subscriber selects a field name 116 and puts it in the third set 104. The subscriber may select the field name 116 from the owner's 112 second set 106. The field names of each set 104, 106, 108 are displayed to the user at the first internet site 12 and the second internet site 38. Again, each of the sites has questions which are unique to each of the sites 20, 52 and questions that are shared 108.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A method of registering information for a user in a centralized user database accessible by a plurality of subscribers, said method comprising the steps of,
establishing a first internet site (12) having a first plurality of identity fields (14),
inputting user information into the first plurality of identity fields (14),
establishing a centralized user database (24) comprising a master list of identity fields (26),
linking the centralized user database (24) to the first internet site (12),
comparing the master list of identity fields (26) to the first plurality of identity fields (14),
registering the user information from the first plurality of identity fields (14) into the centralized user database (24),
establishing a second internet site (32) having a second plurality of identity fields (34),
linking the centralized user database (24) to the second internet site (32),
said method characterized by populating the user information registered in the centralized user database (24) from the first internet site (12) into the second plurality of identity fields (34) on the second internet site (32).

2. A method as set forth in claim 1 including identifying a user at the second internet site (32) and populating the user information into the second internet site (32) in response to identifying the user.

3. A method as set forth in claim 2 wherein the step of establishing the second internet site (32) further includes having one additional identity field (40) different than the first plurality of identity fields (14) and the second plurality of identity fields (34), inputting additional user information into the additional identity field (40) at the second internet site (32), and registering the additional user information from the second internet site (32) into the centralized user database (24).

4. A method as set forth in claim 3 wherein the step of registering the additional user information further includes creating the additional identity field (40) in the centralized user database (24).

5. A method as set forth in claim 3 wherein the step of creating the additional identity (40) field further includes creating an additional identity field (40) that is unique to the second internet site (32).

6. A method as set forth in claim 1 further characterized by registering the user information for a plurality of users into the centralized user database (24) and identifying the user information for each of the plurality of users with a dedicated identifier for each user.

7. A method as set forth in claim 1 wherein the step of comparing the master list of identity fields (26) further includes linking the master list of identity fields (26) and the plurality of identity fields to a field description database (30) for matching the user information input by the user to the master list of identity fields (26).

8. A method as set forth in claim 1 including creating additional identity fields (40) in the centralized user database (24) in response to a request from either one of the internet sites.

9. A method as set forth in claim 1 including creating a first set (102) of identity fields accessible by a owner (112) of the user database (24) that are required to be displayed on the first internet site (12) and the second internet site (32).

10. A method as set forth in claim 1 including creating a second set (106) of identity fields accessible by the owner (112) for displaying to the user (18) at either one of the first internet site (12) and the second internet site (32).

11. A method as set forth in claim 1 including creating a third set (104) of identity fields accessible by a subscriber (28) for displaying to the user (18) at the internet site of the subscriber (28).

12. A method as set forth in claim 1 further characterized by providing each of the internet sites with an access code for establishing communication with and retrieving user information from the centralized user database (24).

13. A method as set forth in claim 12 wherein the step of retrieving the user information further includes accessing a predetermined number of identity fields.

14. A method as set forth in claim 1 further characterized by replacing the user information in the centralized user database (24) with new user information in response to the user information registered in the centralized user database (24) being different than the new information input by the user at one of the internet sites.
